(19) United States
(12) Patent Application Publication
(10) Pub. No.: US 2019/0012650 A1
(43) Pub. Date: Jan. 10, 2019

(54) MACHINE VERIFICATION SYSTEM

(71) Applicant: JUN-YI HE, Taichung City (TW)

(72) Inventor: JUN-YI HE, Taichung City (TW)

(21) Appl. No.: 15/642,909

(22) Filed: Jul. 6, 2017

(51) Int. Cl. G06Q 20/20; G06Q 50/00

(52) U.S. Cl. CPC G06Q 20/206; G06Q 20/02; G06Q 50/01

(57) ABSTRACT

A machine verification system is provided, including a machine, an online server and a user end. The machine has identification information which corresponds to the machine and has a prompt unit. The online server is communicatively connected to the machine via internet. The user end is communicatively connected to the online server via the internet. The user end sends, via the internet, a request information which matches the identification information, through the online server and to the machine, the machine displays information to be verified on the prompt unit, the user end obtains the information to be verified on the prompt unit and sends, via the internet, verification information which matches the information to be verified through the online server to the machine, and if the verification information matches the information to be verified, the machine executes an operation command.

### BACKGROUND OF THE INVENTION

### Field of the Invention

The present invention relates to a machine verification system which has a two-factor verification feature.

### Description of the Prior Art

In recent years, since technology advances and consuming ability lifts, people tend to shop for convenience; therefore, many businesses arrange products in vending machines (for example, skill cranes, game arcades or beverage machines) to increase sale channels. Thanks to popularity of internet, the machines can be connected to an online server through the internet, so the businesses introduce membership which allows members to get offers and promotions to increase their purchase intention so as to retain consumers and generate more new consumers. When a user connects the online server with a device (for example, a cell phone) via the internet and enters identification information of the machine (for example, a machine number), s/he can get the offer of the machine and uses the machine or purchases products in the machine with an online payment feature which is a benefit for the members.

However, the membership of the conventional machine does not have a secure verification system, the machine is unable to effectively determine if a user in front of the machine is one of the members, and when the member is not in front of the machine, the user can still initiate an interactive operation between the machine and the member (for example, entering wrong machine information), and the user may operate the machine and purchases the products which are not ordered by the member. There is a huge risk of the account being hacked.

The present invention has arisen to mitigate and/or obviate the afore-described disadvantages.

### SUMMARY OF THE INVENTION

The major object of the present invention is to provide a machine verification system, which can effectively ensure that a user is in front of a machine so as to allow a user end to operate the machine.

To achieve the above and other objects, a machine verification system is provided, including a machine, an online server and a user end. The machine has identification information which corresponds to the machine and has a prompt unit. The online server is communicatively connected to the machine via internet. The user end is communicatively connected to the online server via the internet. The user end sends, via the internet, a request information which matches the identification information, through the online server and to the machine, the machine displays information to be verified on the prompt unit, the user end obtains the information to be verified on the prompt unit and sends, via the internet, verification information which matches the information to be verified through the online server to the machine, and if the verification information matches the information to be verified, the machine executes an operation command.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a structure drawing of a preferred embodiment of the present invention; and

FIG. 2 is a structure diagram of the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

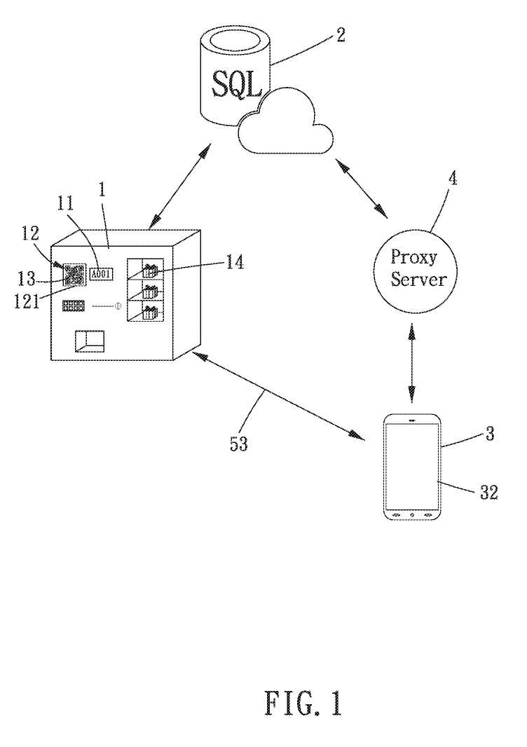

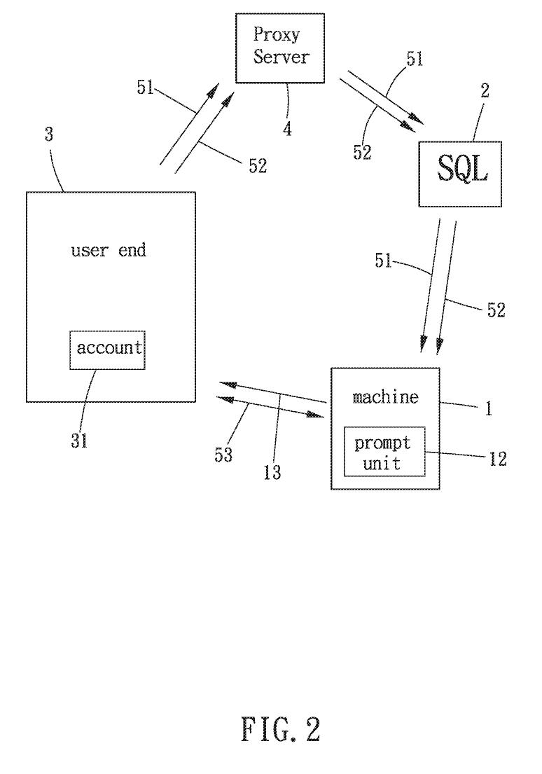

Please refer to FIGS. 1 and 2 for a preferred embodiment of the present invention, and a machine verification system includes a machine 1, an online server 2 and a user end 3.

The machine 1 has identification information 11 which corresponds to the machine 1, the identification information 11 is text information or a QR code (in this embodiment, the identification information 11 is the text information), and the machine 1 has a prompt unit 12. In this embodiment, the machine 1 is a vending machine, and in other embodiments, the machine 1 may be an add value machine, a ticket dispenser, a coin change machine or other machines.

The online server 2 is communicatively connected to the machine 1 via internet.

The user end 3 is communicatively connected to the online server 2 via the internet. In this embodiment, the user end 3 includes a cell phone 32 for portability; and in other embodiments, the user end 3 may include a tablet, a notebook or other communication products.

The user end 3 sends, via the internet, a request information 51 which matches the identification information 11, through the online server 2 and to the machine 1, the machine 1 displays information to be verified 13 on the prompt unit 12, the user end 3 obtains the information to be verified 13 on the prompt unit 12 and sends, via the internet, verification information 52 which matches the information to be verified 13 through the online server 2 to the machine 1, and if the verification information 52 matches the information to be verified 13, the machine 1 executes an operation command 53.

Specifically, preferably the prompt unit 12 is a display device 121, and the information to be verified 13 is the text information or the QR code. In this embodiment, the information to be verified 13 is the QR code so that the user end 3 can scan the QR code via the cell phone so as to ensure that the user end 3 is in front of the machine 1.

The operation command 53 includes that the machine 1 provides offer information to the user end 3 or sends free gifts to the user end 3 or that the user end 3 can directly purchases a product 14 in the machine 1. In this embodiment, the operation command 53 includes the above-mentioned operation commands 53 which can effectively increase the purchase intention of consumers.

In addition, the machine verification system further includes a proxy server 4, the proxy server 4 is connected to the user end 3 and the online server 2 via the internet, the proxy server 4 includes Facebook, LINE, WeChat, WhatsApp, BeeTalk, Twitter, Myspace, Google+ or social websites for live broadcast, and in this embodiment, the proxy server 4 is Facebook. After the user end 3 sends the request information 51 to the proxy server 4 via the internet, the proxy server 4 sends the request information 51 to the online server 2. Therefore, the consumer can use an account of a social website directly to apply for membership and log in so as to connect the online server 2 via the internet.

Furthermore, the user end 3 further includes an account 31, the user end 3 broadcasts live video through the proxy server 4 for audience to watch, the audience who watch the live video can donate a payment optionally, the payment is added to the account 31 of the user end 3, preferably, the account 31 is an account which is for third-party payment, and balance in the account 31 is used to purchase a product 14 in the machine 1. Therefore, it is a win-win situation that businesses can promote their products through the live video, and the consumer of the user end 3 can earn revenue through the live video.

In other embodiments, the machine 1 is an add value machine, the user end 3 further includes an account 31, after the machine 1 executes the operation command 53, the add value machine gives credits to the account 31, and the credits in the account 31 can be used to purchase products in other machines. For example, a restaurant owner can set up the machine 1, and after a client purchases his/her product, the owner can ask the client to go through a verification process to get credits so as to attract clients to visit the restaurant.

In addition, in other embodiments, the machine 1 is a skill crane or a game arcade, the online server 2 further includes a LINE official account, after the user end 3 adds the LINE official account, the user end 3 sends, via the internet, the request information 51 which matches the identification information 11 to the LINE official account and through the LINE official account to the machine 1, after the machine 1 displays the information to be verified 13 on the prompt unit 12, the user end 3 obtains the information to be verified 13 on the prompt unit 12 and sends, via the internet, the verification information 52 which matches the information to be verified 13 through the LINE official account to the machine 1, if the verification information 52 matches the information to be verified 13, the machine 1 executes the operation command 53, and the user end 3 can play the machine 1 for free once. By playing the machine 1 for free once, the possibility of the user end 3 adding the LINE official account increases, and the popularity and topicality of the LINE official account rise so as to effectively increase the purchase intention of the consumer. Besides, the LINE official account does not permit the user ends 3 who add the LINE official account to send message privately so as to protect the privacy of the user ends 3 and prevent personal information from leaking.

Given the above, in the machine verification system, the user end obtains the information to be verified on the prompt unit and sends, via the internet, the verification information which matches the information to be verified through the online server to the machine, and if the verification information matches the information to be verified, the machine executes the operation command With two-factor verification, the user end can be prevented from being hacked.

While we have shown and described various embodiments in accordance with the present invention, it should be clear to those skilled in the art that further embodiments may be made without departing from the scope of the present invention.

What is claimed is:

1. A machine verification system, including:
a machine, having identification information which corresponds to the machine and having a prompt unit;
an online server, communicatively connected to the machine via internet;
a user end, communicatively connected to the online server via the internet; wherein the user end sends, via the internet, a request information which matches the identification information, through the online server and to the machine, the machine displays information to be verified on the prompt unit, the user end obtains the information to be verified on the prompt unit and sends, via the internet, verification information which matches the information to be verified through the online server to the machine, and if the verification information matches the information to be verified, the machine executes an operation command.

2. The machine verification system of claim 1, wherein the machine is a vending machine, an add value machine, a ticket dispenser or a coin change machine.

3. The machine verification system of claim 1, wherein the identification information is text information or a QR code.

4. The machine verification system of claim 1, wherein the prompt unit is a display device, and the information to be verified is text information or a QR code.

5. The machine verification system of claim 1, wherein the operation command includes that the machine provides offer information to the user end or sends free gifts to the user end or that the user end can directly purchases a product in the machine.

6. The machine verification system of claim 1, further including a proxy server, the proxy server connected to the user end and the online server via the internet, the proxy server including Facebook, LINE, WeChat, WhatsApp, BeeTalk, Twitter, Myspace, Google+ or social websites for live broadcast, wherein after the user end sends the request information to the proxy server via the internet, the proxy server sends the request information to the online server.

7. The machine verification system of claim 1, wherein the user end further includes an account, the user end broadcasts live video through the proxy server for audience to watch, the audience who watch the live video can donate a payment optionally, the payment is added to the account of the user end, and balance in the account is used to purchase a product in the machine.

8. The machine verification system of claim 7, wherein the account is an account which is for third-party payment.

9. The machine verification system of claim 1, wherein the machine is an add value machine, the user end further includes an account, after the machine executes the operation command, the add value machine gives credits to the account, and the credits in the account can be used to purchase products in other machines.

10. The machine verification system of claim 1, wherein the machine is a skill crane or a game arcade, the online server further includes a LINE official account, after the user end sends, via the internet, the request information which matches the identification information to the LINE official account and through the LINE official account to the machine, after the machine displays the information to be verified on the prompt unit, the user end obtains the information to be verified on the prompt unit and sends, via the internet, the verification information which matches the information to be verified through the LINE official account to the machine, if the verification information matches the information to be verified, the machine executes the operation command, and the user end can play the machine for free once.
